(19) United States
(12) Patent Application Publication
(10) Pub. No.: US 2008/0000324 A1
(43) Pub. Date: Jan. 3, 2008

(54) Construction and use of asymmetrical centrifugal force generating devices

(76) Inventor: Jan Charles Biro, San Francisco, CA (US)

Correspondence Address: Jan Charles Biro, Apt. 1205, 88 Howard, San Francisco, CA, 94105, US

(21) Appl. No.: 11/820,101

(22) Filed: Jun. 18, 2007

Related U.S. Application Data
(60) Provisional application No. 60/818,205, filed on Jul. 3, 2006.

(51) Int. Cl. F03G 3/00

(52) U.S. Cl. 74/84 R

(57) ABSTRACT

I have designed and constructed three mechanical devices, each to generate asymmetrical centrifugal forces. Devices 1 and 2 generates asymmetrical centrifugal forces by varying the rotation radius of a mass, while device 3 generates asymmetrical centrifugal force by restricting the location of the rotating mass to one preferential part of the rotating path. These and similar devices are suggested for moving (transport) objects in any designed, predetermined direction of the 3D space in any penetrable medium like gas, fluid, vacuum, et cetera (ground, marine, air, spacecraft propulsion).

### CROSS REFERENCE TO RELATED APPLICATION

The subject matter of the present application relates to and encompasses the disclosure of U.S. Provisional Patent Application No. 60/818,205, Filing Date Jul. 3, 2006 in the name of Jan Charles Biro for “CONSTRUCTION AND USE OF AN ASYMMETRICAL CENTRIFUGAL FORCE GENERATING DEVICE (ACFGD)”. The disclosure of such provisional application is hereby incorporated herein by reference in its entirety, for all purposes.

### STATEMENT FEDERALLY SPONSORED RESEARCH

Not applicable

### LISTINGS

Not applicable

### BACKGROUND OF THE INVENTION

1. Field of the Invention

Motors, transportation, centrifugal force, propulsion,

2. Background of the Related Art

Centrifugal Force is a fictitious force arising in a rotating reference system. It points away from the center, in the direction opposite to the centripetal acceleration.

F=mω²r

where F=centrifugal force [N], m=mass [kg], ω=angular velocity [rads⁻¹] r=distance from center of rotation [m].

If the path of the rotation is a circle (or other symmetrical path) the center of rotation (o) remains stable (not moving). However if the path of the rotation is asymmetrical (the r is longer in one preferential direction than in ±180° direction) or the distribution of the rotating mass (m) is asymmetrical (the m is larger in one preferential direction than in ±180° direction) the F will increase in that preferential direction and the center of rotation will move in that preferential direction. Therefore asymmetrical centrifugal forces will able to move an object in any (predefined or preferential) direction of the 3D space (FIG. 1). This invention is to create asymmetrical centrifugal force by creating asymmetrical mass distribution around the center of rotation (FIGS. 1b, d).

### BRIEF SUMMARY OF THE INVENTION

I have designed and constructed three mechanical devices, each to generate asymmetrical centrifugal forces. Devices 1 and 2 generates asymmetrical centrifugal forces by varying the rotation radius of a mass, while device 3 generates asymmetrical centrifugal force by restricting the location of the rotating mass to one preferential part of the rotating path. These and similar devices are suggested for moving (transport) objects in any designed, predetermined direction of the 3D space in any penetrable medium like gas, fluid, vacuum, et cetera (ground, marine, air, spacecraft propulsion).

### BRIEF DESCRIPTION OF THE FIGURES

FIG. 1. Generating of Asymmetrical Centrifugal Forces (ACF).

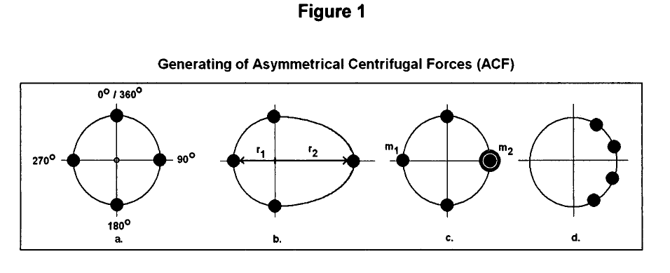

It is possible to introduce asymmetry into a symmetrically rotating system (a) by increasing rotating radius in one direction (b: r2>r1), by increasing mass in one direction (c: m2>m1) or restricting the location of the mass to one preferential part of the rotating path (d).

FIG. 2: Device 1—side view

Pairs of masses (m) are rigidly attached to each other by axis (a). The axis is freely moving through a rotating shaft (s). When the shaft rotates, the masses are also rotating around the shaft and tend to follow a circular, symmetrical path. (A) However the path of rotation may be kept asymmetrical by a barrier (b). (B). Arrows indicate the direction and size of centrifugal forces (F).

FIG. 3: Device 2

A mass (m) is mounted on a shaft which is comprised of 6 joint segments (s1-s6). The shaft is rotated by a gear (g2) and folded by an other gear (g1). The mass will rotate along (A, C) or around (outside) (B, D) of the shaft axis as the result of the circular and axial movements of the shaft. The shaft is supported by hangars (h1, h2). A and B are upper while C and D are side views.

FIG. 4: Rotation Axes and Angles.

A ring is rotating sagitally around x-axis (in z-y plane) and a mass (m) is moving laterally around the ring. The ρ, μ, ξ indicate rotation angles in z-y, z-x and x-y planes.

FIG. 5: Movements of the Ring and Mass in ACFGD.

The sagital rotation of the ring around the x-axes defines a sphere (compare to FIG. 4). The lateral movement of a mass on this ring (increasing numbers) defines a path. The upper- and side-projections of this path are symmetrical (upper and lower right spheres) while the frontal-projection is asymmetrical (left bellow sphere). The central sphere indicates the x, y, z axis and the rotation planes. (This figure is to use as Front Page View in patent publications, therefore the title of the patent and the name of the inventor are also included).

FIG. 6: Example for ECFGD

Pairs of masses (m) are suspended on mass-shafts (ms) and rigidly attached to each other by axis (a). The axis is freely moving in holes (h) through a rotating shaft (s) which are supported by shaft holders (sh). When the shaft rotates, the masses are also rotating around the shaft and tend to follow a circular path. This path of rotation is kept asymmetrical by a barrier (b). The barrier is suspended on barrier axes (ba) and barrier holders (bh). The arrows indicate the shaft rotation provided by some external rotating force. t: supporting table.

FIG. 7: Construction of an ACFGD.

g: gears, r: rings, m: mass, b: bearing boll.

FIG. 8: Construction of an ACFGD, 3D view.

g: gears, r: rings, m: mass, b: bearing bolls

### DETAILED DESCRIPTION OF THE INVENTION

### Device 1.

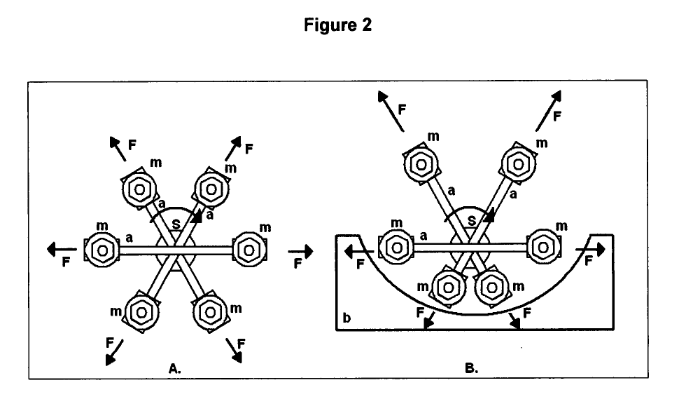

A simple way to accomplish asymmetrical path—and asymmetrical centrifugal force—is using a barrier, which modifies a circular motion of a mass (FIG. 2.)

### Device 2

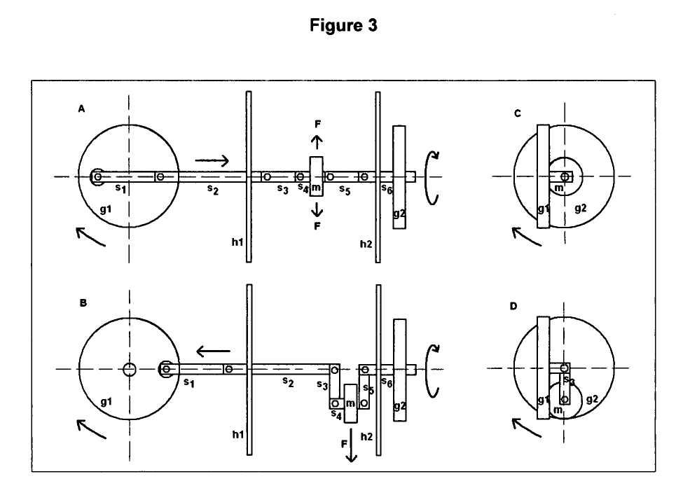

Combination of two rotating motions (in two dimensions) can also result in an asymmetrical path and asymmetrical centrifugal force. (FIG. 3).

### Device 3

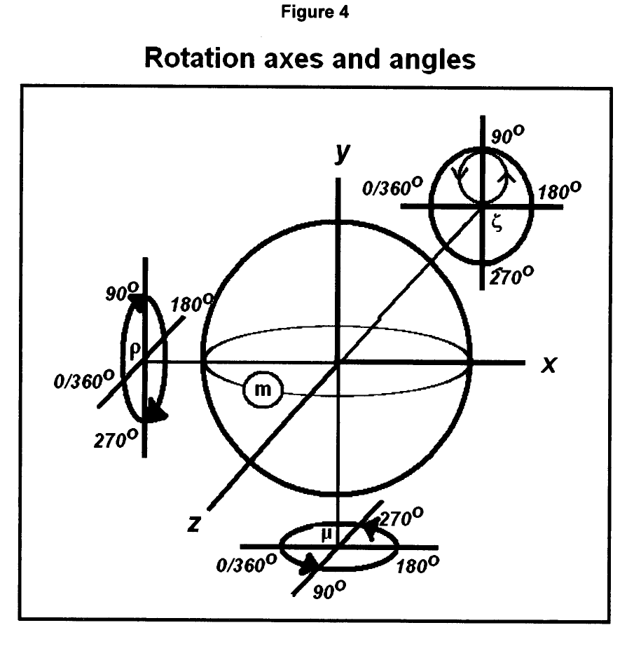

In this design (FIG. 4) a ring is rotating around say x-axis with an angular velocity (ωᵣ) and a mass (m) is moving around this ring (angular velocity (ωₘ). Synchronize the rotating of the ring and the mass on the ring using the following criteria:
ωᵣ=ωₘ
when ρ=0°, μ should be=0°
when ρ=180°, μ should be=180°

### These criteria guaranties that the mass always remains on the upper half of the rotations hemisphere, i.e. the generated centrifugal forces remain asymmetrical.

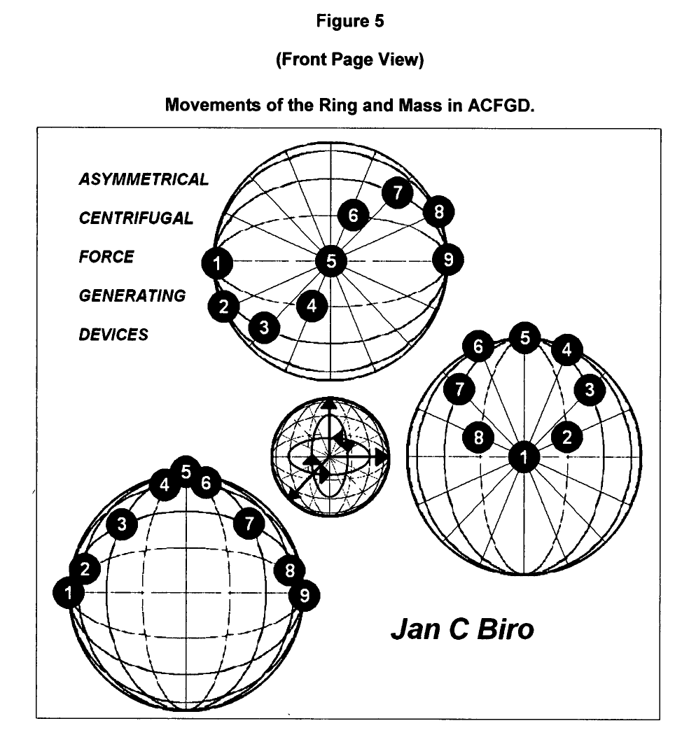

The sagital rotation of the ring is synchronized with the lateral movement of the mass on the ring. This creates an asymmetrical loop and generates asymmetrical centrifugal forces. The asymmetrical nature of the path is illustrated by FIG. 5.

### EXAMPLES

### Example 1

### Detailed Description of a Device 1

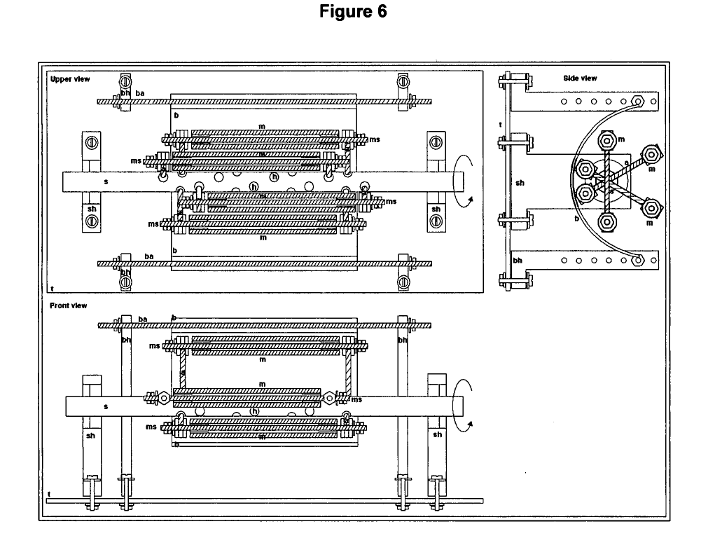

This example provides one possible mechanical solution for the device 1. This device consists of 3 pairs of cylindrical masses which are kept in rotation by a rotating shaft. The masses are not rigidly attached to the shaft but their distance to the shaft can very. The naturally circular path of rotation is kept asymmetrical with a U-shaped mechanical barrier. (FIG. 6)

The forces used to keep the rotation of masses asymmetrical and achieve the necessary function of the device 1 may be electrical or magnetic forces too (in addition to mechanical). I these cases the masses supposed to have electrical charges or magnetic properties.

### Example 2

### Detailed Description of a Device 3

This example provides one possible mechanical solution for the device 3.

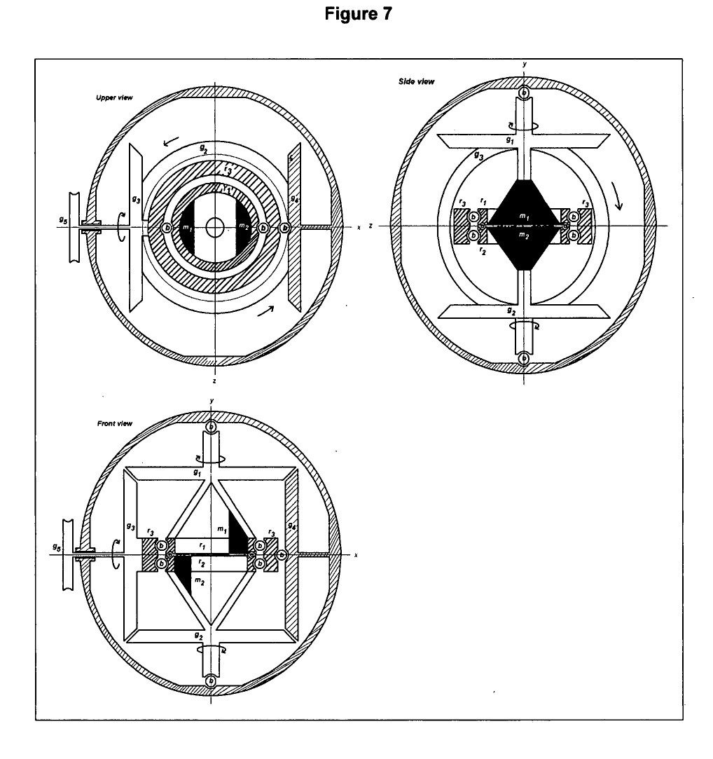

This device consists of four gears (g1, g2, g3, g4), 3 rings (r1, r2, r3) and 2 rotating mass (m1, m2). R1 is rigidly attached to g1 and r2 is rigidly attached to g2 (FIG. 7).

The r1 and r2 are placed opposite to each other and will rotate in opposite directions. The third ring, r3 is rigidly attached to g3 and this ring houses r1 and r2. R1 and r2 rotate independently of each other within r3 (bearing bolls). G3 is perpendicular to g1 and g2 and rotates these rings in opposite directions. G3 itself is rotated by g5 through an axis.

The forth gear (g4) is stationary, not rotating, it is rigidly attached to the housing of the device. The rotating g1 and g2 rotates r1 and r2, however they are “rolling around” the edge of g4 but not rotating it. This “rolling around” motion of g1 and g2 turns r3 (and the in-housed r1 and r2) sagitally around the x-axis.

Two identical masses (m1=m2) are attached to r1 and r2 opposite (±180° rotational difference) to each other. These two masses follow the sagital (z-y), rotation of the ring as well as the lateral path on the r1 and r2.

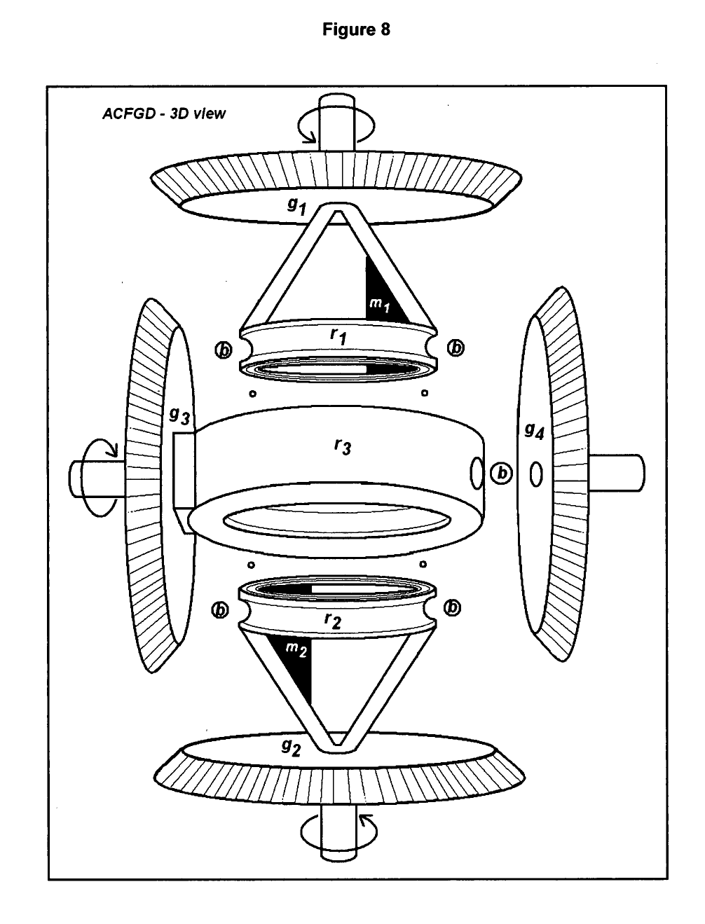

The 3D view of this ACFGD is shown in FIG. 8.

### Patentability

1. Novelty: The inventor does know any similar method (asymmetrical centrifugal force propelled movement) for transportation.

2. Non-obvious: The inventor does know any similar method (asymmetrical centrifugal force propelled movement) for transportation.

3. Industrial application: The inventor wish to use the ACFGD to move object (transportation) in different penetrable media (water, air, including vacuum, et cetera)

That which is claimed is:

1. methods and devices (device 1, device 2, device 3) generating asymmetrical centrifugal forces.

2. methods and devices (device 1, device 2, device 3) utilizing asymmetrical centrifugal forces for moving (transporting) objects in any designed, predetermined direction of the 3D space

3. methods and devices (device 1, device 2, device 3) utilizing asymmetrical centrifugal forces for moving (transporting) objects in any penetrable medium like gas, fluid, vacuum, et cetera (ground, marine, air, spacecraft propulsion).

4. device 1 referred in claims 1-3 generates asymmetrical centrifugal force by keeping a rotating mass on eccentric path with an external force or barrier.

5. device 2 referred in claim 1-3 generates asymmetrical centrifugal force by keeping a rotating mass on eccentric path by periodic folding and relaxing the rotation axis (shaft).

6. device 3 referred in claim 1-3 generates asymmetrical centrifugal force by keeping a rotating mass on eccentric path by secondary, perpendicular rotation of the primary circular rotation path.
